(19) United States
(12) Patent Application Publication
(10) Pub. No.: US 2003/0155892 A1
(43) Pub. Date: Aug. 21, 2003

(54) Universal apparatus and method for charging batteries

(76) Inventor: Sergio Poletti, Crevalcore (IT)

Correspondence Address: WILLIAM COLLARD, COLLARD & ROE, P.C., 1077 NORTHERN BOULEVARD, ROSLYN, NY, 11576, US

(21) Appl. No.: 10/275,362

(22) PCT Filed: May 3, 2001
(86) PCT No.: PCT/IB01/00768

(30) Foreign Application Priority Data
May 5, 2000 (IT) MO2000A000090

(51) Int. Cl. H02J 7/00

(52) U.S. Cl. 320/137

(57) ABSTRACT

A universal apparatus for charging batteries comprising power means, suitable for providing the electric energy for charging a battery, said power means being enslaved to control means suitable for controlling the voltage and the current supplied by said power means; the apparatus further comprises programming means for programming said control means. A method for charging a battery comprising connecting the battery with power supply means, suitable for supplying the battery with the electric energy necessary for charging said battery, enslaving said power supply means to control means, suitable for adjusting the electric quantities, voltage and current, supplied by said supply means; the method further comprises programming said control means so that said control means is suitable for driving said supply means for carrying out a charging procedure of said battery according to pre-established parameters.

The invention relates to an apparatus for charging batteries, in particular to an active apparatus, i.e. suitable for fitting to any typology of batteries, to any configuration of charge curves of the battery and for detecting, and possibly for signalling, anomalies which take place during the charging procedure of a battery. From prior art, apparatus for charging batteries of substantially passive type are known, i.e. apparatus in which only the charging voltage of the battery can be set by the user, while the supplied current is not controllable and only depends on the conditions of the battery to be charged.

This type of apparatus may be generally used for charging a single typology of batteries, with the consequence that a user, which needs to charge batteries of different type, has to get charging apparatus of different type, one for each type of battery, with remarkable increase of costs.

Apparatus' for charging batteries are further known which are arranged for charging batteries of different type and/or for different charging procedures. However the setting of this apparatus, provided by the producer, can not be modified by the user, which wants to use said apparatus for types of batteries or for charging procedures for which said apparatus have not been arranged.

The present invention aims to solve the above-mentioned drawbacks.

According to the present invention an apparatus for charging batteries is provided comprising power means, suitable for supplying the electric power for charging a battery, said power means being enslaved to control means suitable for controlling voltage and current supplied by said power means, characterized in that it further comprises programming means for programming said control means.

Owing to the invention it is possible to charge a battery optimising, at any moment, the values of the voltage applied to the battery and the current supplied to the battery, reproducing the optimal charging curve provided by the producer of the battery. The possibility of programming the control means of the apparatus according to the invention, makes possible to further use the apparatus for charging any type of battery, and, then, to use the same apparatus for a plurality of batteries of different type, with remarkable saving of costs for the user.

The user may program in advance the type of charging curve, i.e. the type of charging procedure to be used and, possibly, the user may modify said charging curve according to his particular requirements. Furthermore the apparatus may be programmed also for batteries of new generation, without modifying said apparatus, since it is always possible to define the parameters of the charging procedure, i.e. voltage, current and times.

The apparatus according to the invention further allows the charging procedure of a battery to be divided into a series of steps, mutually interactive, so as to automatically fit the charging procedure to the effective condition of the battery, so optimising, at any moment, the same procedure, preventing any risk of damaging the battery and notably extending the service life thereof.

The invention will be now described below, for simple exemplifying and not restrictive purpose, with reference to the attached drawings, in which:

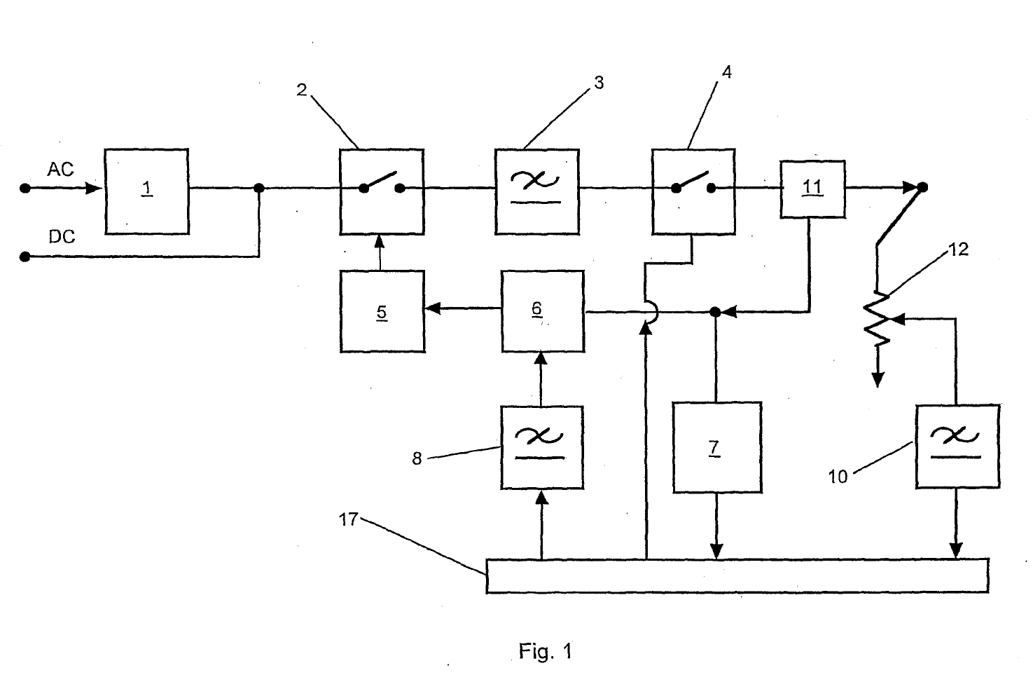

FIG. 1 is a block diagram of the power means of the apparatus according to the invention;

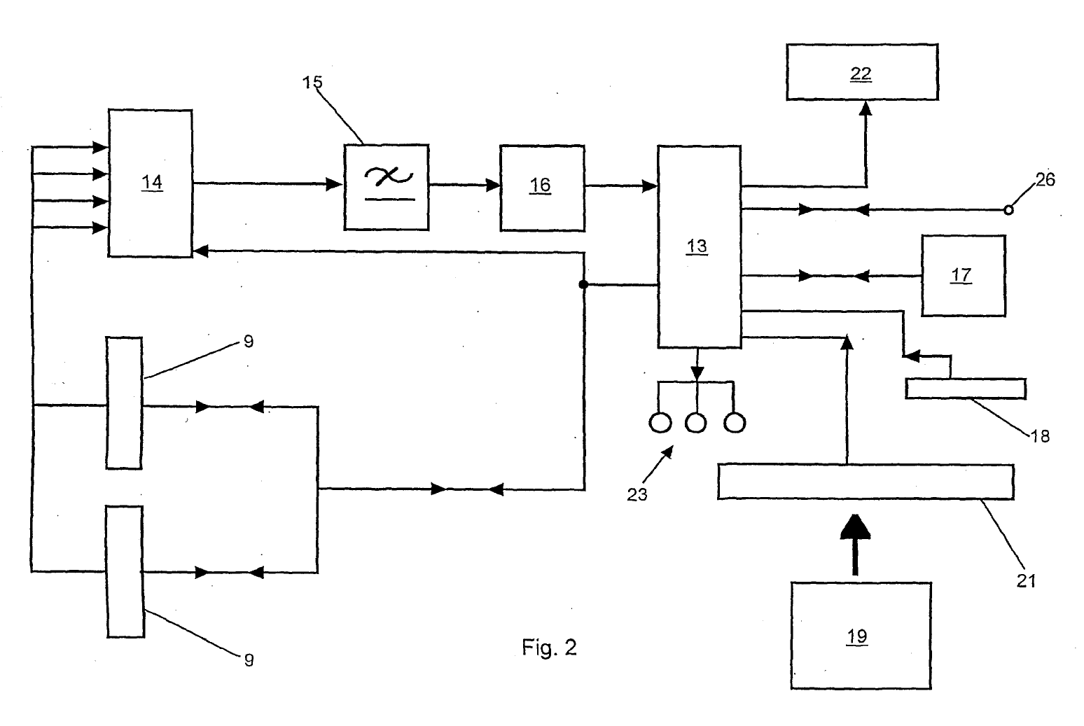

FIG. 2 is a block diagram of the control means of an apparatus according to the invention;

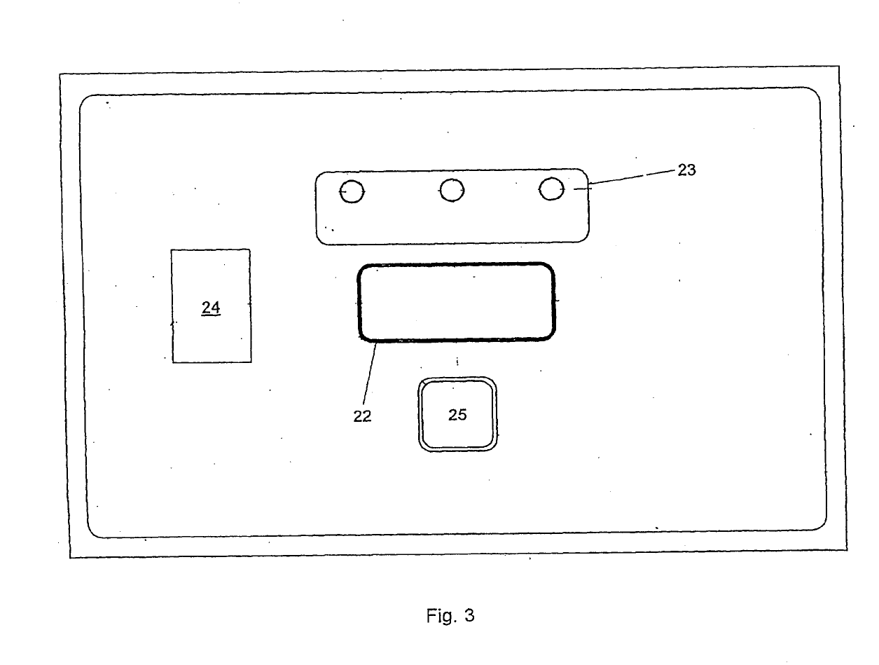

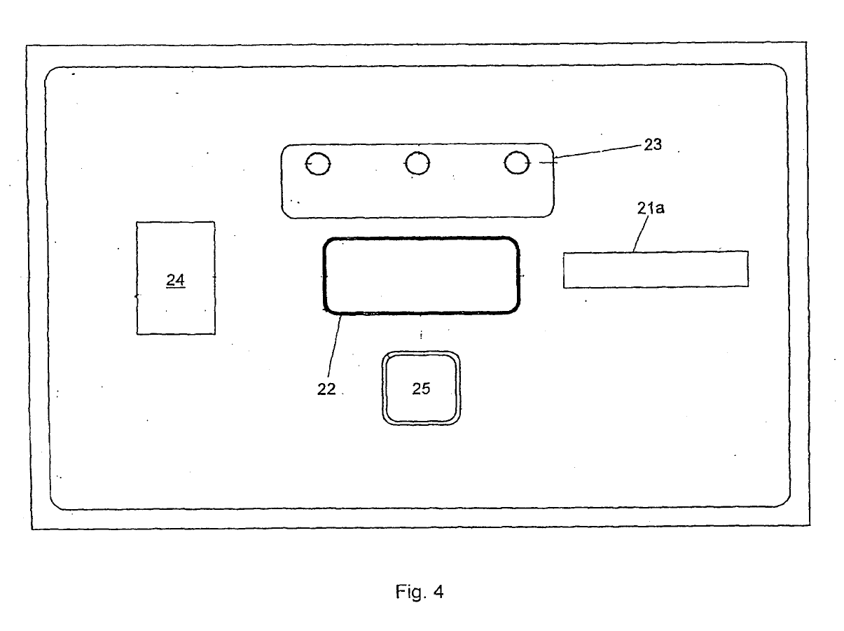

FIGS. 3 and 4 are sketched views of two versions of a front panel of the apparatus according to the invention.

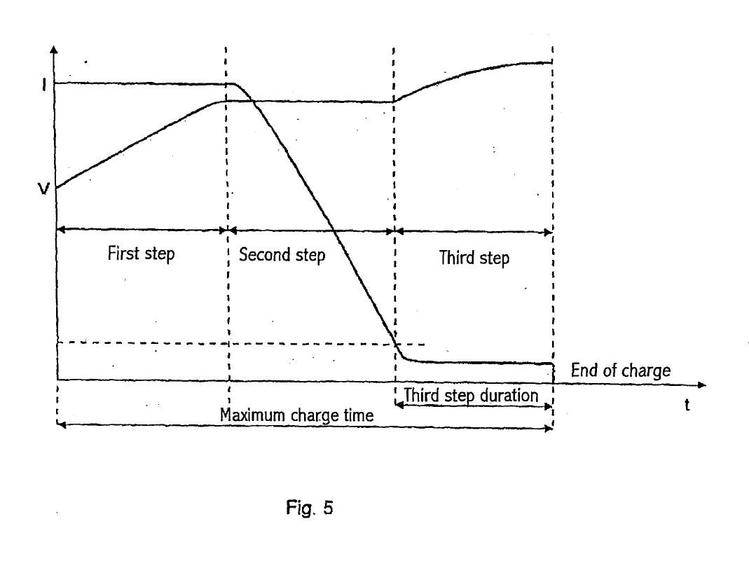

FIG. 5 is an example of a charge curve of a battery during a charging procedure which may be carried out with the apparatus according to the invention.

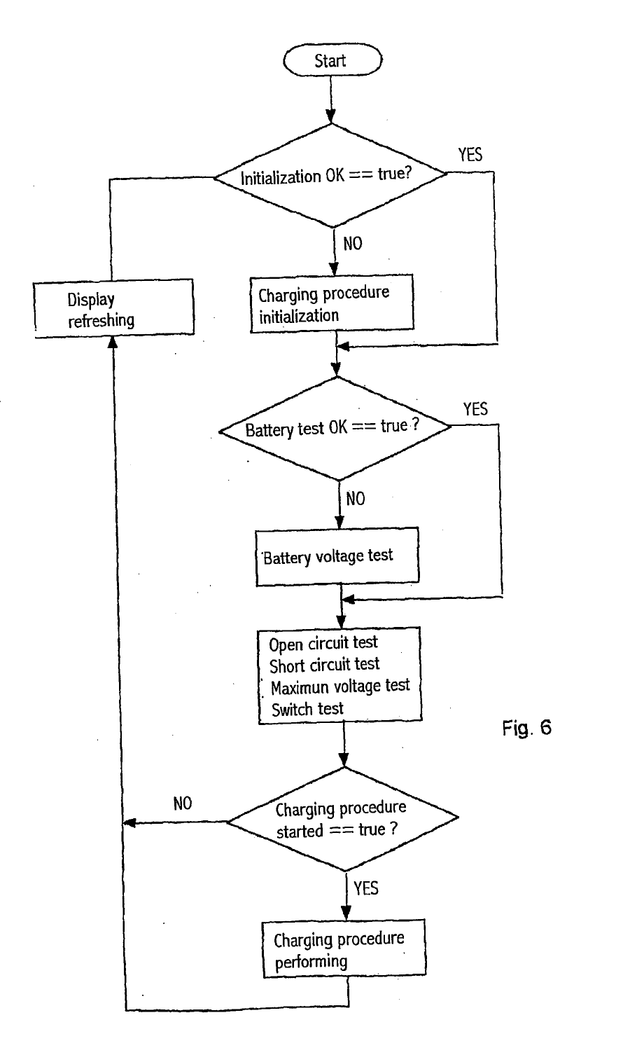

In FIG. 6 a flow diagram is shown which illustrates how the apparatus according to the invention works during a charging procedure of a battery.

In FIG. 1 a block diagram of a power unit of the apparatus according to the invention is shown.

The apparatus may comprise a plurality of power units, substantially identical to each other, mutually connected in parallel, for fitting to batteries of different power.

The use of power units substantially identical to each other allows a remarkable saving of costs, since it is possible to manufacture, by using the same components, i.e. the power units, apparatus for charging batteries of any power, connecting in parallel the number of power units necessary for obtaining the desired power.

A single-phase or three-phase transformer connected with the electric mains, which reduces the value of the mains voltage, for example 220 V or 380 V, to values of the order of a few dozens of volt and galvanically separates the power units from the supplying electric means, supplies the power units.

The power units may also be directly supplied by the electric mains, through an automatic phase corrector, with a high frequency insulating transformer.

A power unit comprises an AC/DC converter, supplied by said transformer, which converts the alternating current supply of the electric means into direct current supply. When the apparatus is fed directly by a direct current supply means, the AC/DC converter and the transformer are not necessary.

The AC/DC converter is connected in series with a power controller 2, for example comprised of a power MOS-FET, for adjusting the amount of energy supplied, at any moment, to the battery during charging. The power controller 2 converts the direct current supply into a series of impulses of current of adjustable duration. In series with the controller 2 a reconstructive filter 3 is arranged, which converts the impulses of current generated by the controller 2 into a direct current. In series with the reconstructive filter 3 a circuit breaker relay 4 connected with the battery terminals through a current sensor 11 is arranged, which detects the intensity of the current provided to the battery terminals and generates a signal proportional to said intensity. The circuit breaker relay 4 is further connected with a control and drive unit of the power unit, which controls opening and closing of said relay 4.

The signal generated by the sensor 11 is sent to a conditioning device 7, which processes the signal for making it manageable by the control unit and, then, to the same control unit, which will be described hereinafter. To said control and drive unit a signal proportional to the voltage at the battery terminals is further sent. Said voltage may be detected for example by a voltage divider 12, and the voltage signal generated by the voltage divider 12 may be sent to the control and drive unit through a low-pass, deglitcher filter 10.

The signal generated by the current sensor 11 is further sent to a comparator device 6, which compares the signal of the current sensor with a reference signal coming from the control and drive unit through a reconstructive filter 8.

The reference signal coming from the control and drive device is proportional to the current intensity which, at any moment, has to be provided to the battery, on the basis of the charging curve of the battery programmed in the device. A difference between the intensity of the reference signal and the intensity of the signal generated by the current sensor 11 means that the current actually provided to the battery does not correspond to the current which should be provided. In this event, the comparator device 6 actuates a drive circuit 5 of the power controller 2, for adjusting the value of the current absorbed by the battery so as to match the theoretical required value. In FIG. 2 a block diagram of the control and drive unit of the power units is shown.

This unit comprises a microprocessor 13 which detects the signals generated by the current sensors 11 of the various power units, proportional to the intensity of the current which each power unit supplies to the battery, the signal generated by the voltage divider 12, proportional to the voltage at the battery terminals, and a signal generated by a possible temperature sensor, proportional to the temperature of the battery being charged, or to a temperature representative of the temperature of the battery being charged.

The signals coming from the current sensors 11, the voltage divider 12 and the temperature sensor are detected cyclically at pre-established intervals of time by a multiplexer, or selector, 14 driven by the microprocessor 13 and sent to the microprocessor 13 through a low-pass filter 15 for removing possible noise and an analog-to-digital converter 16, which converts said signals, of analogic type, into signals of digital type. Through connecting means 9, the microprocessor 13 sends to the comparator devices 6 of the different power units reference signals for adjusting the current which each power unit provides to the battery and signals for opening and closing the circuit breaker relays 4, for connecting the battery with the power units at the beginning of the charging cycle, for disconnecting the battery from one or more power units during the charging cycle, if it is necessary, and for disconnecting the battery from all the power units at the end of the charging cycle, or when anomalous conditions requiring the charging cycle to be stopped take place.

The parameters concerning the different charging steps of the battery, according to the curve, or the curves of charging, to be carried out, are stored into a memory 17 of EEPROM type, connected with the microprocessor 16, which may be updated by the user. The memory 17 may be updated in different ways.

According to a first way, the memory 17 may be updated through a data recording support 19, for example a magnetic card, a smart-card, a floppy-disc, which is read by a suitable reader 21 which the apparatus according to the invention may be provided with. The data concerning a charging cycle of the battery to be charged are stored on the support 19; these data are transferred by the reader 21 to the memory 17 so updating the memory contents with the above-mentioned data. For allowing the support 19 to be recognized by a user, the data concerning the characteristic parameters of the battery and the types of charging curves, whose data are stored into the support 19, are printed in a label applied on the support 19.

According to another way, the data of the memory 17 may be updated through a data processor, for example a personal computer which may be connected with the microprocessor 13 through a serial port 26 provided in the apparatus according to the invention. In this case, the data are updated by the microprocessor 13, on the basis of the instructions received by the personal computer.

A plurality of charging procedures selectable through a suitable selector may also be stored into the memory 17.

The microprocessor 13 may be further connected with a display 22 and to a set of warning lamp 23 arranged on a front panel of the apparatus according to the invention. The display 22 allows to visualise data concerning the type of battery to be charged, the type of charging curve of the battery, and the parameters pertaining to the different charging steps, for example: charging current, voltage at the battery terminals, elapsed time from beginning of the charge, ampere-hours supplied and energy used by the apparatus from the beginning of the charge. The display 22 further allows alarm messages signalling anomalous conditions to be visualized. The warning lamps are used for signalling the different steps of the charging cycle and said possible anomalous conditions.

In FIG. 3 a first example of front panel of an apparatus according to the invention is shown, comprising a starting switch 24, for manually switching on and or off the apparatus according to the invention, the display device 22, the warning lamp 23 and one or more selecting push-buttons 25, for example for changing the type of data visualised on the display 22, for starting a testing procedure of the apparatus, for programming the EEPROM memory 17, for selecting a charging procedure among a plurality of procedures stored into said memory 17. In FIG. 4 second example of front panel of an apparatus according to the invention is shown, in which in addition to the starting switch 24, the display 22 and the warning lamp 23 a slot 21a is provided for inserting a data recording support 19, for example a smart-card, into the reader 21, for updating the memory 17.

In FIG. 5 a charging curve of a battery is shown which may be obtained using the apparatus according to the invention. The apparatus according to the invention allows the charging procedure of a battery to be managed by subdividing said procedure into a series of subsequent steps on the basis of the charging curve provided by the producer and managing said steps both in autonomous way and in interactive way.

The quantities involved in each step of the charging procedure are the voltage V at the ends of the battery terminals, the current I absorbed by the battery, i.e. the charging current, the time, i.e. the elapsed time from the beginning of the charging procedure and the temperature of the battery.

During each step of the charging procedure, one of the two electric quantities, voltage or current, is taken as independent reference variable and is kept constant, while the other electric quantity, representing the dependent variable, is allowed to vary freely, checking that said electric quantity does not exceed a maximum pre-established value, or does not fall below a minimum pre-established value.

For example, with reference to FIG. 5, in which the charging curve of a lead battery is shown, the charging procedure is subdivided into three steps:

in a first initial step the charging current I is kept constant and the voltage V is allowed to vary freely. This first step is considered completed when the voltage V at the ends of the battery terminals has reached a first pre-established value. At this point, the second step of the charging procedure starts, in which the voltage V reached at the end of the first step is kept constant and the charging current I is allowed to freely vary, until the current intensity I has dropped to a pre-established value. The third and last step of the charging procedure is a timed step with constant current and voltage freely variable, i.e. a step of pre-established duration, at the end of which the voltage at the ends of the battery terminals must have reached a pre-established value.

If at the end of each step of the charging procedure the dependent variable, i.e. the one which may freely vary, has not reached the provided value, the apparatus may be programmed so as to repeat, or continue, this step until the independent variable reaches the provided value, or a breakdown of the charging cycle can be programmed, definitive or temporary, depending on the safety requirements, in order to avoid damage of the battery.

In any case, the single steps of the charging procedure may be programmed so that the value reached by the dependent variable causes the temporary or definitive stop of the charging procedure, an anomalous condition being signalled, or the passage to the following step of the charging procedure, or the continuation of the charging step in progress.

For each charging step, and/or for the whole charging procedure, a maximum time may be provided, after which the charging procedure is stopped, an anomalous condition being signalled.

During the whole charging procedure monitoring of the temperature of the battery, or of a temperature representative of the temperature of the battery, by means of the temperature sensor mentioned in advance may also be provided. Monitoring is used, inter alia, for carrying out adjustments of the value of the charging voltage depending on said temperature. Furthermore, said monitoring is used for carrying out an automatic compensation of the voltage drops in cables connecting the apparatus and the battery being charged. Finally, when the temperature exceeds a maximum pre-established value, break-down of the charging procedure may be provided.

In all the steps of the charging procedure it is further checked that the charging current does not exceed a pre-established maximum value, the overrunning of which may indicate a short circuit of the apparatus. If this fact takes place, the charging procedure is immediately stopped.

The apparatus according to the invention may be programmed in different ways, for example loading into the memory 17 of the control and drive unit, through the reader 21, the data concerning the various steps of the charging procedure stored on a smart-card, or loading the above-mentioned data from the memory of a personal computer connected with the apparatus according to the invention through the serial port 26, or, still, loading the above-mentioned data from an internal memory of the microprocessor 13, or by actuating a selector device 18 external or internal to the apparatus, for example a selector constituted by a plurality of mechanical micro-switches, or by optical micro-switches, suitable for being actuated through a punched card.

For loading the data from a smart-card, first of all it is necessary to turn off the apparatus according to the invention, if it is turned on, to insert the smart-card into the reader 21, to turn on the apparatus, to wait that a message is visualised on the display 22, indicating that the data contained on the smart-card have been load, to turn off the apparatus and to extract the smart-card. At this point the apparatus is ready to be used.

Advantageously the above-mentioned data loading process from a smart-card, owing to its simplicity and safety, may be used as standard or default procedure, when the apparatus is prearranged for other procedures of data loading.

The microprocessor 13, during the data loading step from the smart-card, controls that a smart-card incompatible with the apparatus has not been inserted, i.e. a smart-card pertaining to charging procedures which require a current or a voltage higher than the maximum values of voltage and current the apparatus may supply, or a smart-card suitable for an apparatus of a different type. The latter control is possible, by storing into each smart-card a code identifying the apparatus for which the smart-card is suitable and by comparing this code with an identical code stored in the memory 17.

The apparatus is programmed so as to start the battery charging procedure if, when the apparatus is turned on, there is no smart card into the reader 21 and there is a battery connected with the apparatus. If, instead, there is a smart card inserted into the reader, the apparatus proceeds to load the data in the smart card.

When the charging procedure is started, the reader 21 is disabled, so that, if a smart card is inserted thereinto when a charging procedure is in progress, the apparatus is not capable to load the data contained into the smart card, which certainly would interfere with the charging procedure in progress.

FIG. 6 shows a flow diagram which illustrates how the apparatus according to the invention works during a charging procedure of a battery.

When the apparatus in turned on, the microprocessor 13 checks, on the basis of the value of a first code stored into the memory 17, whether the initialisation of the apparatus has been executed and, in the negative case, starts an initialisation procedure which resets all the configuration registers and the timers, checks that the relay 4 is in the opening position and, in negative case, switches said relay to the opening position; finally the microprocessor 13 assigns to said first code the value corresponding to the occurred execution of the initialisation procedure.

Subsequently, the microprocessor 13 controls, on the basis of a second code stored into the memory 17, whether a test of the battery connected with the apparatus has been executed. This test is used mainly to verify that the battery is compatible with the apparatus. If the test of the battery has not been executed, the microprocessor 13 starts a testing procedure of the battery verifying that the voltage at the battery terminals is not lower than a pre-established value, for example 1V and if the connected battery is of a type compatible with the apparatus.

Once the test of the battery has been performed, the microprocessor 13 assigns to said second code a value corresponding to the occurred execution of the test and passes to the next step.

In this subsequent step, the microprocessor 13 load from the memory 17, or from a data recording support 19 inserted into the reader 21, the charging curve to be carried out and the parameters pertaining to the first step of the charging procedure. Then, the microprocessor 13 controls closing of the relay 4 and starts the first step of the charging procedure.

During the charging procedure, the microprocessor 13 checks, at pre-established intervals of time, that the battery is actually connected with the apparatus, that values of voltage or current do not become greater than a respective pre-established maximum value, in which case the microprocessor 13 immediately controls the stop of the charging procedure, for avoiding damages of the battery and visualises on the digital display 22 a message signalling that an anomalous condition has taken place.

The microprocessor 13 also checks, at pre-established intervals of time, the value of the dependent variable, voltage or charging current, of the step of the charging procedure in process and, when said value has reached a pre-established limit value, the microprocessor 13 loads from the memory 17 the parameters of the next step of the charging procedure and controls starting of said next step.

Furthermore, during the whole step of the charging cycle in process, the microprocessor controls that the value of the independent variable remains constant. This control takes place on the basis of the reading of the values of the independent variable sent to the microprocessor, at pre-established intervals of time, from the power units, through the multiplexer, or selector, 14. The microprocessor provides to verify, at pre-established intervals of time, that the temperature of the battery, or a temperature representative of the temperature of the battery, detected by a suitable sensor, does not exceed a pre-established maximum value, in which case the microprocessor 13 controls stopping of the charging cycle and visualizing on the display 22 of a message signalling that the overheating of the battery has taken place. Finally, the microprocessor provides for updating the timers pertaining to the execution of the charging-procedure and for updating the display 22, by cyclically visualising the data concerning the quantities involved in the charging procedure, such as voltage, charging current, charging time, ampere-hours absorbed by the battery, energy absorbed by the apparatus according to the invention.

The apparatus according to the invention may be used for keeping a battery charged during the use thereof. Therefore, a restoration cycle of the charge of a battery can be provided, said cycle being to be used when the battery charge amount decreases below a pre-established value, even if the battery is not completely flat. In this case, the apparatus has to be permanently connected with the battery and the microprocessor 13 checks, at pre-established intervals of time, the voltage at the battery terminals, starting the restoring cycle of the charge, when said voltage drops below a pre-established value.

1. Universal apparatus for charging batteries comprising power means, suitable for supplying the electric energy for charging a battery, said power means being enslaved to control means suitable for controlling the voltage and the current supplied by said power means, characterised in that it further comprises programming means for programming said control means.

2. Apparatus according to claim 1, wherein said control means comprises microprocessor means (13), operatively connected with said power means.

3. Apparatus according to claim 1, or 2, wherein said programming means comprises storing data means (17) functionally connected with said microprocessor means (13).

4. Apparatus according to any one of the preceding claims, wherein said programming means comprises reading means (21) functionally connected with said data storing means (17) for reading a data storing support.

5. Apparatus according to claim 4, wherein said reading means (21) is reading means for reading a data storing support of smart-card type.

6. Apparatus according to claim 4, wherein said reading means (21) is reading means for reading a data storing support of magnetic type.

7. Apparatus according to claim 4, wherein said reading means (21) is reading means for reading a data storing support of optic type.

8. Apparatus according to any of the claims 2 to 7, wherein said programming means comprises selector means (18) functionally connected with said microprocessor means (13).

9. Apparatus according to claim 8, wherein said selector means (18) comprises a plurality of mechanical microswitches.

10. Apparatus according to claim 8, wherein said selector means (18) comprises a plurality of optic microswitches suitable for being actuated by a punched card.

11. Apparatus according to any one of the preceding claims, wherein connection means (26) is provided for connecting said microprocessor means (13) with data processing means external to the apparatus.

12. Apparatus according to any of the preceding claims, wherein said power means comprises at least one power unit functionally connected with said control means.

13. Apparatus according to claim 12, wherein said at least one power unit comprises a plurality of power units, mutually connected in parallel.

14. Apparatus according to claim 13 wherein said power units are substantially equal to each other.

15. Apparatus according to any one of claims 12 to 14, wherein said at least one power unit comprises converter means (1), connectable with a source of electric energy, suitable for converting alternating electric power into direct electric power.

16. Apparatus according to any one of claims 12 to 15, wherein said at least one power unit comprises power regulating means (2), functionally connected with said converter means (1), for controlling the amount of energy provided, at any moment, to a battery connected with the apparatus.

17. Apparatus according to any one of claims 12 to 16, wherein said at least one power unit comprises switch means (4) suitable for breaking the electric connection between said power unit and said battery.

18. Apparatus according to any one of claims 12 to 17, wherein said at least one power unit comprises current sensor means (11) suitable for detecting the current supplied by said power unit and for generating a signal proportional to the intensity of said current.

19. Apparatus according to claim 18, wherein said current sensor means (11) is functionally connected with said microprocessor means (13).

20. Apparatus according to claim 19, wherein said at least one power unit comprises comparator means (6), functionally connected with said current sensor means (11) and said microprocessor means (13), said comparator means being suitable for comparing the signal generated by said current sensor means (11) with a reference signal generated by said microprocessor means (13).

21. Apparatus according to any one of claims 12 to 20, wherein said at least one power unit comprises drive means (5) suitable for driving said power regulating means (2).

22. Apparatus according to claim 21, wherein said drive means (5) is functionally connected with said comparator means (6).

23. Apparatus according to any one of claims 12 to 22, wherein said control means comprises connection means (9) suitable for connecting said current sensor means (11), said switch means (4) and said comparator means (6) of each of said power units with said microprocessor means (13).

24. Apparatus according to any one of claims 19 to 23, wherein said current sensor means (11) is connected with said microprocessor means through multiplexer means (14) and analog-to-digital converter means (16) suitable for converting into digital signals the analogic signals generated by said current sensor means (11).

25. Apparatus according to any one of claims 12 to 24, further comprising voltage sensor means (12) connected with said battery and suitable for generating an analogic signal proportional to the voltage at the battery terminals.

26. Apparatus according to claim 25, wherein said voltage sensor means (12) is functionally connected with said microprocessor means (13) through said connection means (9), said multiplexer means (14) and said analog-to-digital converter means (16).

27. Apparatus according to any one of the preceding claims, further comprising display means (22) functionally connected with said microprocessor means (13).

28. Apparatus according to any one of the preceding claims, further comprising signalling means (23), functionally connected with said microprocessor means (13).

29. Apparatus according to claim 28, wherein said signalling means comprises light signalling means (23).

30. Apparatus according to any one of the preceding claims, wherein said power means is supplied through a single-phase or three-phase transformer.

31. Apparatus according to any one of claims 1 to 29, wherein said power means is supplied through automatic phase corrector means with high frequency insulating transformer.

32. Method for charging a battery comprising connecting the battery with supply means, suitable for supplying the battery with the energy necessary for charging said battery, enslaving said supply means to control means, suitable for adjusting the electric quantities, voltage and current, supplied by said supply means, characterised in that it further comprises programming said control means so that said control means is suitable for driving said supply means for carrying out a charging procedure of said battery according to pre-established parameters.

33. Method according to claim 32, wherein said programming comprises reading data stored on a data storing support.

34. Method according to claim 33, wherein said data storing support is of removable type.

35. Method according to claim 34, wherein said data storing support is a smart-card.

36. Method according to claim 34, wherein said data storing support is a support of optic and/or magnetic type.

37. Method according to claim 33, wherein said storing support is a hard disc of a data processing system.

38. Method according to any one of claims 32 to 37, wherein said programming comprises actuating selector means (18) functionally connected with said control means.

39. Method according to claim 38, wherein said selector means (18) comprises a plurality of mechanical micro-switches.

40. Method according to claim 38, wherein said selector means (18) comprises a plurality of optical switches, actuatable by punched card.

41. Method according to any one of claims 32 to 40, wherein said programming comprises subdividing said charging procedure into a plurality of steps capable of being managed either in autonomous way and in interactive way.

42. Method according to claim 41, wherein, in each of said steps one of said electrical quantities is kept constant, while the other electrical quantity is allowed to freely vary.

43. Method according to any one of claims 32 to 42, further comprising detecting the values of said electrical quantities at pre-established interval of time.

44. Method according to claim 43, further comprising adjusting said supply means through said control means for modifying the values of said voltage and/or said current according to the values detected during said detecting.

45. Method according to any one of claims 32 to 44, further comprising breaking said charging procedure when the value of said voltage, and/or said current, exceeds a pre-established value.

46. Method according to any one of claims 32 to 45, further comprising breaking said charging procedure when, in any one of said steps, said quantity which is allowed to vary freely does not reach a pre-established value in a pre-established interval of time.

47. Method according to any one of the claims 32 to 46, further comprising detecting at pre-established intervals of time, the temperature of said battery, or a temperature representative of the temperature of said battery.

48. Method according to claim 47, further comprising breaking said charging procedure when said temperature exceeds a pre-established value.

49. Method according to claim 47, or 48, further comprising correcting the value of said voltage according to said temperature.

50. Method according to any one of claims 47 to 49, further comprising automatically compensating the voltage drop in the cables connecting said battery to said power supply means, as a function of said temperature.
